(19) United States
(12) Patent Application Publication
(10) Pub. No.: US 2026/0303960 A1
(43) Pub. Date: Oct. 1, 2026

(54) INFORMATION PROCESSING DEVICE, INFORMATION PROCESSING METHOD, AND RECORDING MEDIUM

(71) Applicant: SONY GROUP CORPORATION, TOKYO (JP)

(72) Inventor: YIWEN ZHU, TOKYO (JP)

(21) Appl. No.: 19/490,957

(22) PCT Filed: May 27, 2024
(86) PCT No.: PCT/JP2024/019388

§ 371 Date: Dec. 8, 2025

(30) Foreign Application Priority Data
Jun. 15, 2023 (JP) 2023-098317

(51) Int. Cl. H04N 23/60; H04N 23/67; H04N 23/81

(52) U.S. Cl. CPC H04N 23/64; H04N 23/67; H04N 23/81

(57) ABSTRACT

The present technology relates to an information processing device, an information processing method, and a recording medium that can easily avoid occurrence of moire. The information processing device according to the present technology includes an imaging control unit that refers to a database in which a reference imaging parameter related to imaging by a camera that images a display and information indicating presence or absence of moire in a captured image captured by the camera are recorded in association with each other to set the reference imaging parameter associated with information indicating absence of the moire as a current imaging parameter of the camera. The present technology can be applied to, for example, an imaging system used for virtual production in which a subject is imaged with an image displayed on an LED display as a background.

### TECHNICAL FIELD

The present technology relates to an information processing device, an information processing method, and a recording medium, and more particularly, to an information processing device, an information processing method, and a recording medium that can easily avoid occurrence of moire.

### BACKGROUND ART

In recent years, virtual production (in-camera VFX), which is an imaging method using a large light emitting diode (LED) display, has been widespread in imaging movies and dramas.

In the virtual production, imaging is performed with an image displayed on an LED display as a background and a subject arranged in front of the LED display as a foreground. Furthermore, in the virtual production, the image as the background is rendered on the basis of a position of a camera, an orientation of a camera, and a lens profile (see, for example, Patent Document 1).

### CITATION LIST

### Patent Document

Patent Document 1: Japanese Translation of PCT International Application Publication No. 2022-554415

### SUMMARY OF THE INVENTION

### Problems to be Solved by the Invention

When the image displayed on the LED display is captured, moire may occur in the captured image due to a minute deviation between a pixel pitch of the LED display and a pixel pitch of the camera. Conventionally, a photographer manually adjusts an imaging parameter at the time of imaging to avoid occurrence of moire.

There are a plurality of imaging parameters that can be adjusted to avoid the occurrence of moire, and there is a limit to manually adjusting the plurality of imaging parameters. Furthermore, since the imaging parameters after adjustment are not recorded, even in a case where imaging is performed at a later date under the same imaging condition, it is necessary to perform the imaging parameter adjustment operation again in order to avoid the occurrence of moire.

The present technology has been made in view of such a situation, and is intended to avoid occurrence of moire.

### Solutions to Problems

An information processing device according to a first aspect of the present technology includes an imaging control unit that refers to a database in which a reference imaging parameter related to imaging by a camera that images a display and information indicating presence or absence of moire in a captured image captured by the camera are recorded in association with each other to set the reference imaging parameter associated with information indicating absence of the moire as a current imaging parameter of the camera.

An information processing method according to the first aspect of the present technology includes, by an information processing device, referring to a database in which a reference imaging parameter related to imaging by a camera that images a display and information indicating presence or absence of moire in a captured image captured by the camera are recorded in association with each other to set the imaging parameter associated with information indicating absence of the moire as a current imaging parameter of the camera.

A recording medium according to the first aspect of the present technology, recording a program for causing a computer to execute processing, the processing including: referring to a database in which a reference imaging parameter related to imaging by a camera that images a display and information indicating presence or absence of moire in a captured image captured by the camera are recorded in association with each other to set the imaging parameter associated with information indicating absence of the moire as a current imaging parameter of the camera.

In the first aspect of the present technology, by referring to a database in which an imaging parameter related to imaging by a camera that images a display and information indicating presence or absence of moire in a captured image captured by the camera are recorded in association with each other to set the imaging parameter for avoiding occurrence of the moire.

### BRIEF DESCRIPTION OF DRAWINGS

FIG. 1 is a diagram for describing an outline of an imaging system to which the present technology is applied.

FIG. 2 is a diagram illustrating an example of a captured image captured by a camera.

FIG. 3 is a diagram illustrating an example of a state during imaging.

FIG. 4 is a diagram for describing a cause of occurrence of moire.

FIG. 5 is a diagram for describing a camera position.

FIG. 6 is a diagram for describing a camera setting value.

FIG. 7 is a diagram illustrating an example of focus adjustment for avoiding occurrence of moire.

FIG. 8 is a flowchart for describing main imaging processing performed by a conventional imaging system.

FIG. 9 is a block diagram illustrating a configuration example of the imaging system.

FIG. 10 is a flowchart for describing imaging preparation processing performed by the imaging system of the present technology.

FIG. 11 is a diagram illustrating an example of a list indicating combinations of imaging parameters.

FIG. 12 is a diagram illustrating an example of a lattice pattern and moire.

FIG. 13 is a flowchart for describing main imaging processing performed by the imaging system of the present technology.

FIG. 14 is a flowchart for describing main imaging processing in a case where imaging preparation processing is not performed.

FIG. 15 is a block diagram illustrating a configuration example of hardware of a computer.

### MODE FOR CARRYING OUT THE INVENTION

Hereinafter, modes for carrying out the present technology will be described. The description will be given in the following order.
1. Outline of imaging system
2. Configuration and operation of imaging system
3. Modifications

### 1. Outline of Imaging System

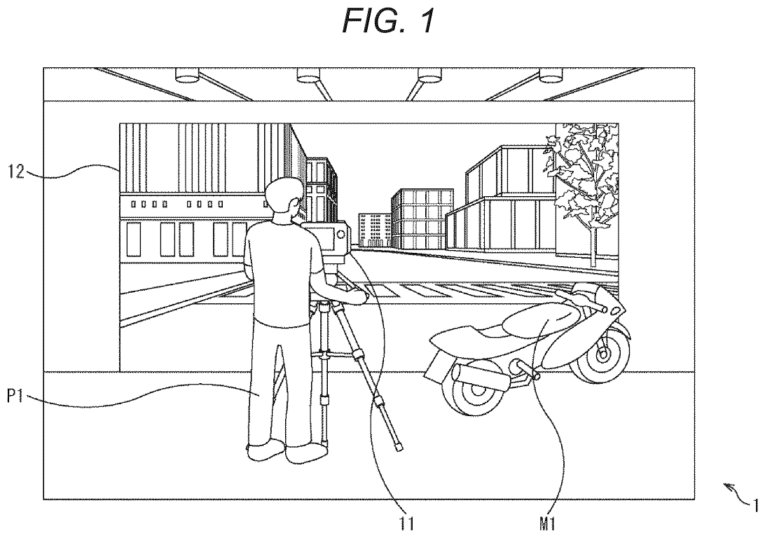

FIG. 1 is a diagram for describing an outline of an imaging system 1 to which the present technology is applied.

The imaging system 1 in FIG. 1 is a system used for imaging by, for example, virtual production (in-camera VFX). The imaging system 1 includes a camera 11, a wall-type light emitting diode (LED) display 12, an information processing device (not illustrated) that controls the camera 11, and a control device (not illustrated) that controls the LED display 12.

The LED display 12 is arranged in a studio or the like. The LED display 12 displays, for example, an image of a virtual space created by computer graphics (CG). A photographer P1 uses the camera 11 to capture an image of a motorcycle M1, which is a subject, with an image displayed on the LED display 12 as a background. Hereinafter, the image displayed on the LED display 12 is referred to as a background image.

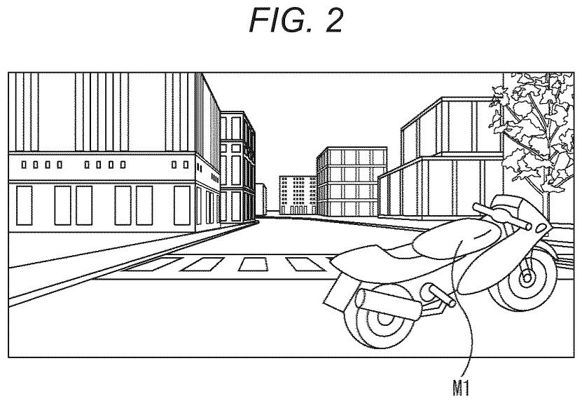

FIG. 2 is a diagram illustrating an example of a captured image captured by the camera 11.

As illustrated in FIG. 2, the captured image captured by the camera 11 is an image in which the motorcycle M1 appears as if it were present in a virtual space reflected in the background image. In this manner, the photographer P1 can thus image, in the studio, a captured image in which a space appearing in the background image spreads in the background of the motorcycle M1 by performing imaging by using the imaging system 1.

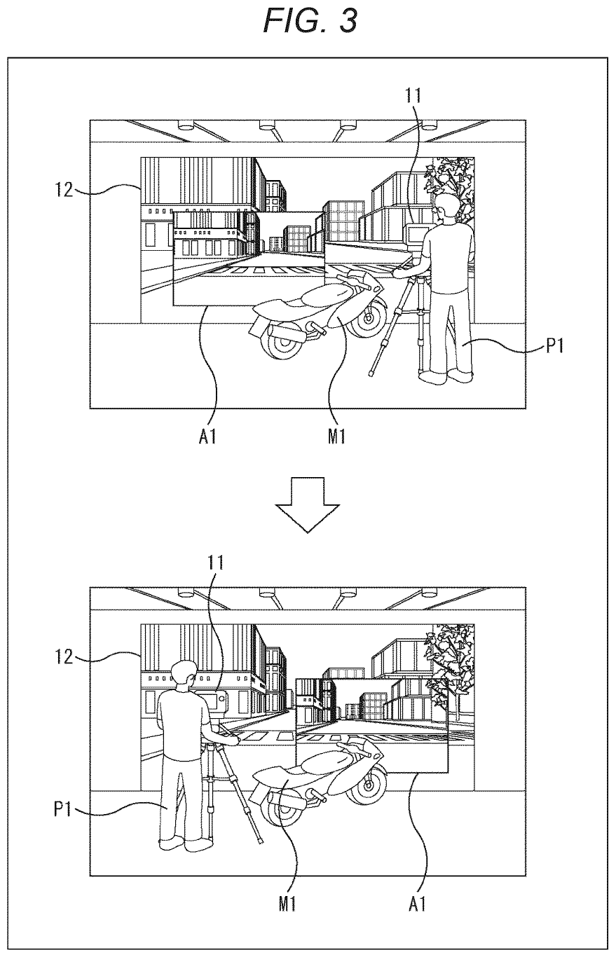

FIG. 3 is a diagram illustrating an example of a state during imaging.

As illustrated in FIG. 3, during imaging, for example, the entire background image is displayed on the entire LED display 12.

As illustrated on an upper side of FIG. 3, in a case where the camera 11 performs imaging from a right side of the motorcycle M1 arranged at a center, a part of the background image is displayed in an imaging area A1, which is an area on the LED display 12 included in an imaging range of the camera 11, in such a way as to be superimposed on the entirety of the background image. In the imaging area A1, for example, an image of a portion of the virtual space appearing in the background image that becomes the background in a case where imaging is performed from the right side of the motorcycle M1 is cut out from the entirety of the background image and displayed.

As illustrated on a lower side of FIG. 3, in a case where the camera 11 performs imaging from a left side of the motorcycle M1 arranged at the center, a part of the background image is displayed in the imaging area A1, in such a way as to be superimposed on the entirety of the background image. In the imaging area A1, for example, an image of a portion of the virtual space appearing in the background image that becomes the background in a case where imaging is performed from the left side of the motorcycle M1 is cut out from the entirety of the background image and displayed.

In this manner, at the time of imaging, the photographer P1 performs imaging while sequentially changing a position, an orientation, a focal length, a focus, and the like of the camera 11. The focal length, focus, and the like of the camera 11 are also changed by the information processing device.

The control device tracks a camerawork (position and posture) of the camera 11, and controls the position of the camera on the LED display 12 where the background image is displayed, according to the camerawork of the camera 11. Specifically, the control device detects the imaging area on the basis of the position, the posture, and the setting of the camera 11, and controls the background image displayed in the imaging area.

Note that although the imaging area A1 is surrounded by a thick line in FIG. 3 for easy understanding of the description, the line surrounding the imaging area is not actually displayed.

When imaging is performed with the background image displayed on the LED display 12 as a background, moire may occur in the captured image.

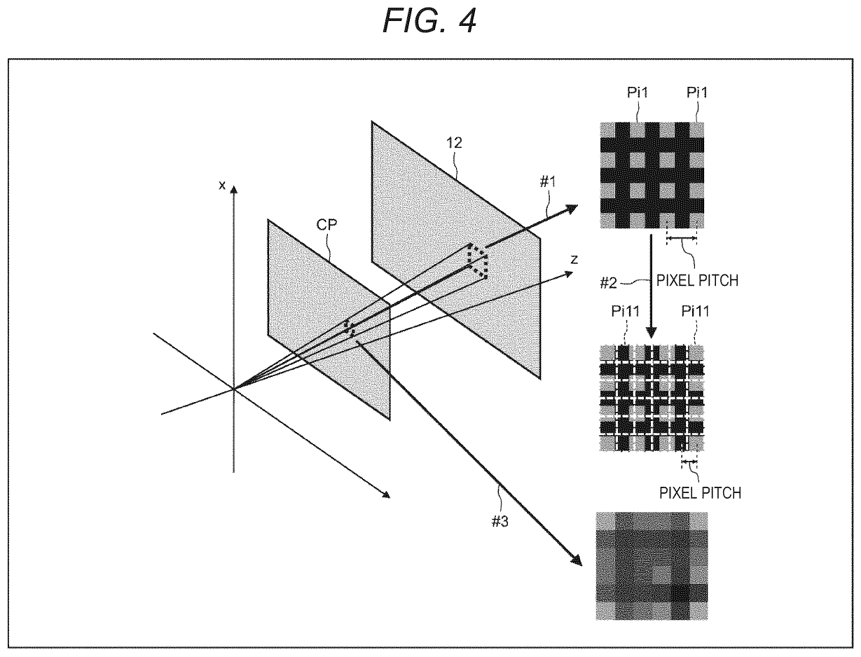

FIG. 4 is a diagram for describing a cause of occurrence of moire.

As illustrated in FIG. 4, the background image displayed on the LED display 12 is projected onto a virtual camera plane CP, and imaging with the background image as the background is performed.

For example, in a case where a uniform background image is displayed on the LED display 12, as indicated by a portion pointed by an arrow #1 in FIG. 4, each pixel Pi1 configuring the LED display 12 emits light of the same color. Hereinafter, a distance between centers of adjacent pixels Pi is referred to as a pixel pitch of the LED display 12.

Furthermore, a distance between centers of adjacent pixels Pi11 among a plurality of pixels Pi11 configuring a sensor provided in the camera 11 is referred to as a pixel pitch of the camera 11. If a pixel pitch of the LED display 12 and a pixel pitch of the camera 11 are different, a minute deviation may occur between the pixel pitch of the LED display 12 and the pixel pitch of the camera 11 depending on the imaging condition.

In a case where the minute deviation occurs, for example, light emitted from one pixel Pi1 may not enter only one pixel Pi11 among the pixels Pi11 surrounded by a broken line at a portion pointed by an arrow #2 in FIG. 4, but may also leak into the adjacent pixel Pi11.

In a case where the light emitted from one pixel Pi1 does not enter only one pixel Pi11 but also leaks into the adjacent pixel Pi11, as indicated by a portion pointed by an arrow #3 in FIG. 4, the captured image does not become an image on which the LED display 12 is accurately projected, and moire (deterioration) occurs in the captured image.

A relationship in size between the pixel pitch of the LED display 12 and the pixel pitch of the camera 11 is affected by a plurality of imaging parameters. The imaging parameters include a value representing a camera position and a camera setting value.

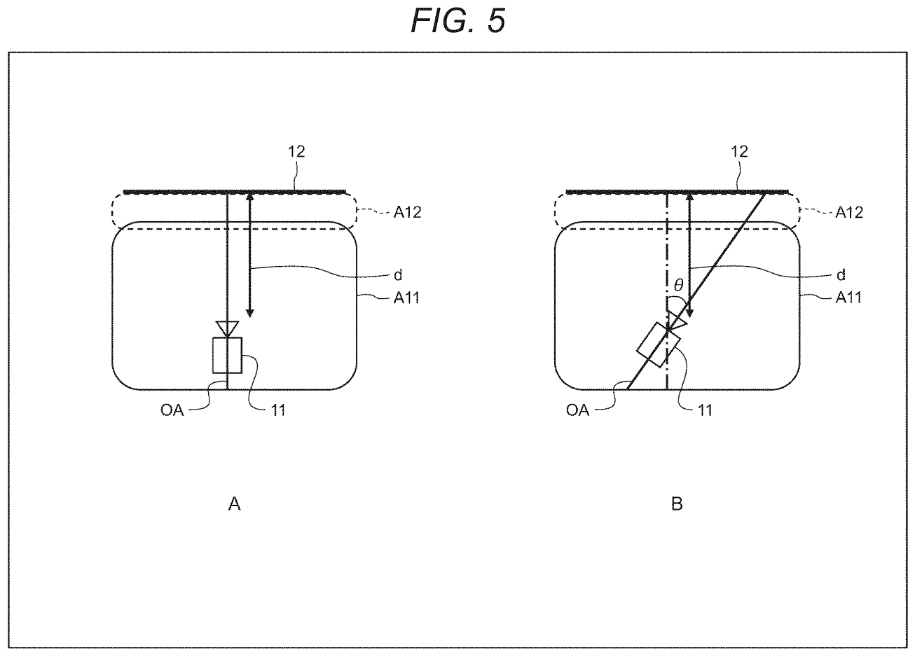

FIG. 5 is a diagram for describing the camera position. FIG. 5 is a plan view of the studio in which imaging by the virtual production is performed. An area A11 in FIG. 5 is an area where the camera 11 can be moved, and an area A12 is an area where the subject can be moved.

The value representing the camera position is a parameter indicating a positional relationship of an object in the studio, such as a distance d between the camera 11 and the LED display 12 and an angle θ of the camera 11 with respect to the LED display 12. The value representing the camera position is acquired by, for example, camera tracking.

As illustrated in A of FIG. 5, the distance d indicates a distance between the camera 11 and the LED display 12 in a case where an optical axis OA of the camera 11 and a display surface of the LED display 12 are perpendicular to each other. As illustrated in B of FIG. 5, the angle θ indicates an angle of the optical axis OA of the camera 11 with respect to an axis perpendicular to the LED display 12 indicated by an alternate long and short dash line.

Note that in FIG. 5, the display surface of the LED display 12 is illustrated as a plane in order to simplify the description, but the shape of the display surface of the LED display 12 is not limited to a plane.

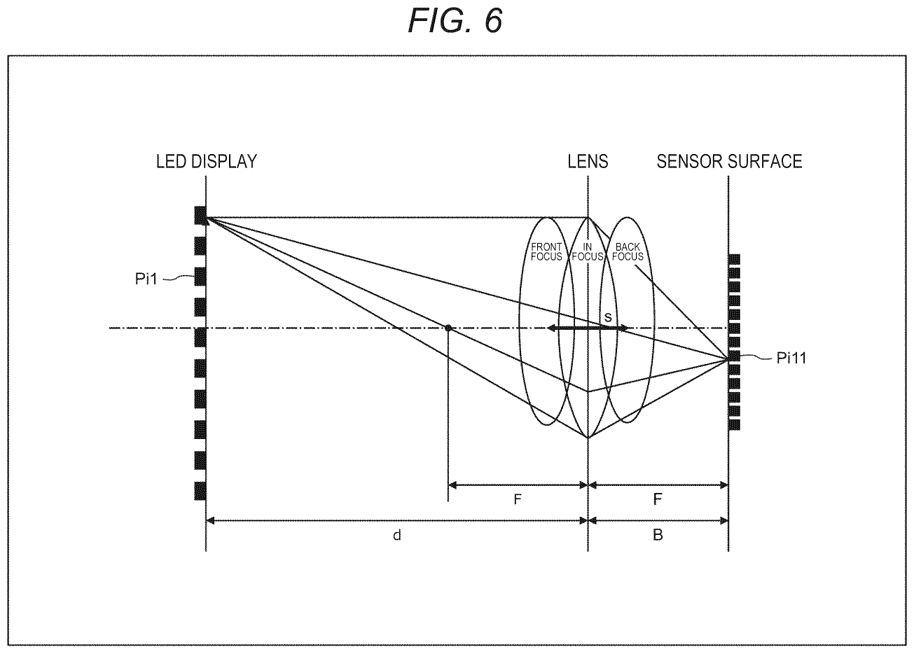

FIG. 6 is a diagram for describing the camera setting value. FIG. 6 illustrates a state in which light emitted from the pixel Pi1 of the LED display 12 forms an image on the pixel Pi11 on a sensor surface of the camera 11 via a lens.

The camera setting value is a parameter indicating setting of a main body of the camera 11, such as a focus s and a focal length F, and is, for example, a parameter determined corresponding to the value representing the camera position. The camera setting value is acquired from the main body of the camera 11, for example.

As illustrated in FIG. 6, the focal length F indicates a focal length of the lens, and the focus s indicates an extension position of the lens, in other words, an in-focus position. By adjusting the focus s, a front focus (a state in which the focus is shifted to the front side (the front side as viewed from the camera 11) of the LED display 12) and a back focus (a state in which the focus is shifted to the back side (the rear side as viewed from the camera 11) of the LED display 12) are realized.

In the example of FIG. 6, the distance d indicates a distance from a display surface of the LED display 12 to a center of the lens in a case where the display surface of the LED display 12 is in focus. Furthermore, a distance B indicates a distance from the center of the lens to the sensor surface in a case where the display surface of the LED display 12 is in focus.

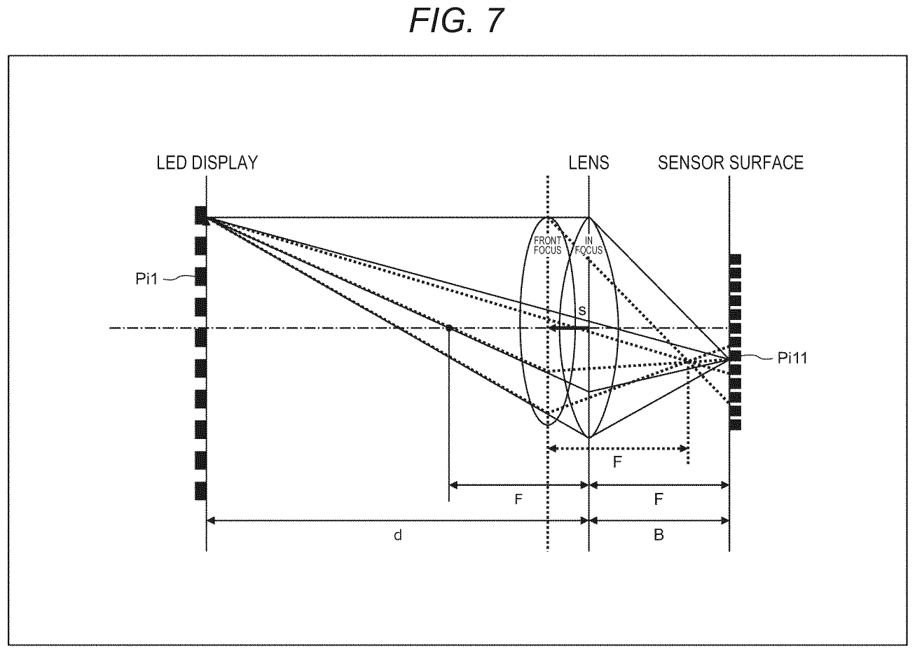

In order to avoid occurrence of moire, it is conventionally recommended to adjust the focus s as illustrated in FIG. 7 while keeping the optical axis of the camera 11 perpendicular to the display surface of the LED display 12. In the example of FIG. 7, the focus s is adjusted such that the display surface of the LED display 12 is not focused and the state of the front focus is obtained.

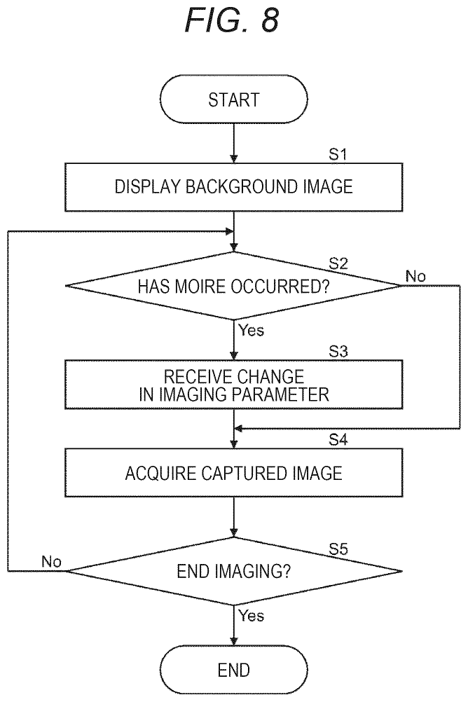

Main imaging processing performed by the conventional imaging system will be described with reference to a flowchart of FIG. 8. By the main imaging processing, imaging by the virtual production is realized.

In step S1, the LED display displays the background image, and the camera starts imaging.

In step S2, the imaging system determines whether or not moire has occurred. For example, the photographer views a monitor (monitoring display) that displays the captured image captured by the camera, confirms whether or not moire has occurred in the captured image, that is, whether or not moire is present in the captured image, and operates the imaging system according to whether or not moire has occurred.

In a case where it is determined in step S2 that the moire has occurred, the processing proceeds to step S3. In step S3, the camera receives a change in the imaging parameter by the photographer. For example, the photographer manually adjusts the focus s while keeping the optical axis of the camera 11 perpendicular to the display surface of the LED display 12 in order to avoid the occurrence of moire. After the imaging parameter is changed, the processing proceeds to step S4.

On the other hand, in a case where it is determined in step S2 that the moire has not occurred, the processing in step S3 is skipped, and the processing proceeds to step S4.

In step S4, the camera captures an image of a subject with the background image as the background, and acquires a captured image.

In step S5, the imaging system determines whether or not to end the imaging.

In a case where it is determined in step S5 not to end the imaging, the processing returns to step S2, and the subsequent processing is performed. In a case where it is determined to end the imaging in step S5, the processing ends.

As described above, conventionally, in order to avoid the occurrence of moire, the photographer needs to manually adjust the focus while keeping the optical axis of the camera perpendicular to the display surface of the LED display.

The adjustment of the focus and limitation of the angle of the camera with respect to the LED display may lead to unintended reduction of the resolution and limitation of the imaging scene. Furthermore, since the adjusted focus and the camera position (for example, the distance between the camera and the LED display) are not recorded, even in a case where imaging is performed at a later date under the same imaging condition, it is necessary to perform adjustment work such as focusing again in order to avoid occurrence of moire, which takes time and effort.

The present technology has been conceived by focusing on the above points, and an imaging parameter suitable for avoiding moire can be automatically calculated and imaging can be made efficient by referring to a database in which an imaging parameter related to imaging by the camera 11 and information indicating presence or absence of moire in the captured image are recorded in association with each other to set the imaging parameter associated with information indicating absence of the moire. In the present disclosure, the imaging parameter to be referred to by the camera 11 recorded in the database may be distinctively referred to as a reference imaging parameter. On the other hand, the imaging parameter currently set for the camera 11 may be referred to as a current imaging parameter.

### 2. Configuration and Operation of Imaging System

### Configuration of Imaging System

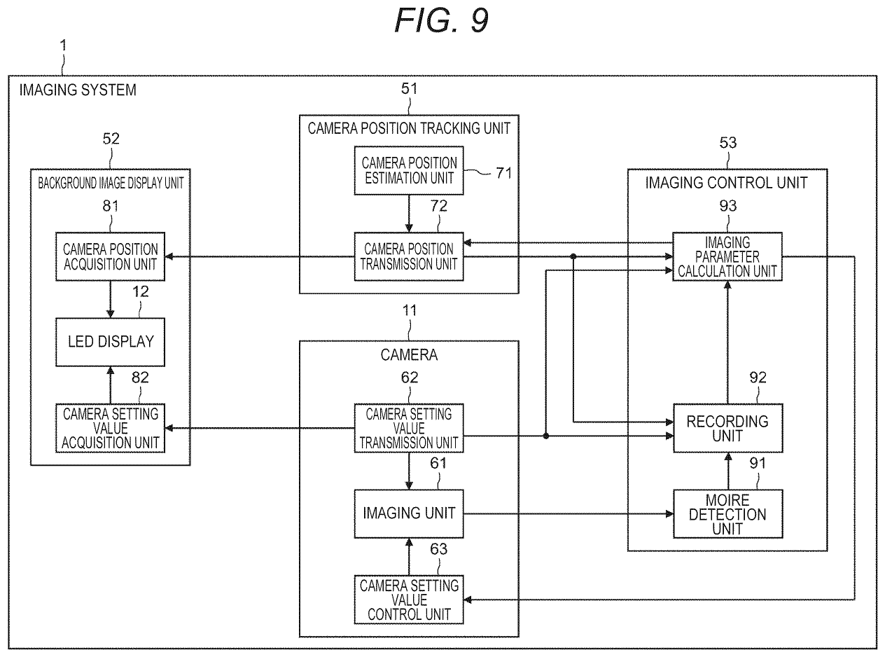

FIG. 9 is a block diagram illustrating a configuration example of the imaging system 1.

As preliminary imaging before main imaging (imaging of a subject), the imaging system 1 in FIG. 9 performs imaging with various combinations of imaging parameters to confirm the presence or absence of moire, and generates a database including the confirmed imaging parameters as reference imaging parameters. Thereafter, in the main imaging, the imaging system calculates the reference imaging parameters that can avoid the occurrence of moire on the basis of the database, controls the current imaging parameters so as to match the reference imaging parameters, and presents information so that the photographer can adjust the current imaging parameters according to the reference imaging parameters.

As illustrated in FIG. 9, the imaging system 1 includes the camera 11, a camera position tracking unit 51, a background image display unit 52, and an imaging control unit 53.

The camera 11 includes an imaging unit 61, a camera setting value transmission unit 62, and a camera setting value control unit 63.

The imaging unit 61 images a subject with a background image displayed on the LED display 12 as a background to acquire a captured image. The imaging unit 61 transmits the captured image to the imaging control unit 53.

The camera setting value transmission unit 62 acquires a current camera setting value from the imaging unit 61, and transmits information indicating the current camera setting value to the background image display unit 52 and the imaging control unit 53.

The camera setting value control unit 63 controls the imaging unit 61 such that the camera setting value (the reference setting value recorded in the database) calculated by the imaging control unit 53 is obtained.

The camera position tracking unit 51 includes a camera position estimation unit 71 and a camera position transmission unit 72.

The camera position estimation unit 71 estimates a current position of the camera 11. In the present disclosure, the current position of the camera 11 may be simply referred to as a current value of the camera position. The current value of the camera position is estimated based on the results of tracking using, for example, an infrared (IR) camera provided in the studio and markers including a retroreflective material. The camera position estimation unit 71 supplies information indicating the current value of the camera position to the camera position transmission unit 72.

The camera position transmission unit 72 transmits the information indicating the current value of the camera position supplied from the camera position estimation unit 71 to the background image display unit 52 and the imaging control unit 53 as current position information of the camera 11.

Although not illustrated, for example, the camera position transmission unit 72 transmits information indicating the camera position (reference value recorded in the database) calculated by the imaging control unit 53 on the basis of the current position of the camera 11 to a display device such as a monitor provided in the camera 11 or a monitor arranged near the photographer, and causes the display device to display the information. As described later, the displayed reference position of the camera 11 represents a relative position with respect to the display 12. In the present disclosure, the camera monitor/display device may be simply referred to as a monitor of the camera or a display device for the camera. The photographer can avoid the occurrence of moire by moving the camera 11 or changing the orientation of the camera 11 such that the reference position displayed on the display device is obtained.

Note that a plurality of candidates for the camera position may be displayed on the display device. In this case, the photographer can select a camera position, from among candidates for the camera position that can avoid the occurrence of moire, so that a desired angle of view is obtained.

The background image display unit 52 includes the LED display 12, a camera position acquisition unit 81, and a camera setting value acquisition unit 82.

The camera position acquisition unit 81 receives the information indicating the current value of the camera position transmitted from the camera position tracking unit 51, and supplies the information to the LED display 12.

The camera setting value acquisition unit 82 receives the information indicating the current camera setting value transmitted from the camera 11, and supplies the information to the LED display 12.

The LED display 12 renders the background image on the basis of the current value of the camera position and the current camera setting value, and displays the background image.

Note that the functions of the camera position acquisition unit 81 and the camera setting value acquisition unit 82 and the function of rendering the background image are realized by a control device such as a PC. In addition to these functions, the function of the camera position tracking unit 51 may be realized by the control device.

The imaging control unit 53 includes a moire detection unit 91, a recording unit 92, and an imaging parameter calculation unit 93.

The moire detection unit 91 detects moire in the captured image captured by the camera 11, and supplies information indicating the presence or absence of moire to the recording unit 92 as a moire detection result.

The recording unit 92 records the information indicating the current camera setting value transmitted from the camera 11, the information indicating the current value of the camera position transmitted from the camera position tracking unit 51, and the moire detection result by the moire detection unit 91 in the database in association with each other. In the present disclosure, the current camera setting value and the current value of the camera position received by the imaging control unit 53 may be referred to as a current imaging parameter.

The imaging parameter calculation unit 93 calculates a reference imaging parameter that can avoid occurrence of moire on the basis of the information indicating the current camera setting value transmitted from the camera 11, the information indicating the current value of the camera position transmitted from the camera position tracking unit 51, and the database recorded in the recording unit 92. For example, the imaging parameter calculation unit 93 searches for the reference imaging parameter that can avoid occurrence of moire on the basis of the current value and the reference value of the camera position.

The imaging parameter calculation unit 93 transmits the calculated (searched) reference imaging parameter to the camera 11 as the current imaging parameter. Specifically, the imaging parameter calculation unit 93 transmits information indicating a camera setting value (reference setting value) among the calculated reference imaging parameters to the camera 11. Furthermore, the imaging parameter calculation unit 93 transmits information indicating a camera position (reference value) among the calculated reference imaging parameters to the camera 11 via the camera position tracking unit 51.

Note that the function of the imaging control unit 53 is realized by an information processing device such as a PC. In addition to the function of the imaging control unit 53, some of the functions of the camera position tracking unit 51 and the background image display unit 52 may be realized by the information processing device.

### Operation of Imaging System 1

The processing performed by the imaging system 1 of the present technology includes imaging preparation processing of recording the reference imaging parameter and the moire detection result in the database as preliminary imaging, and main imaging processing of actually imaging the subject as main imaging.

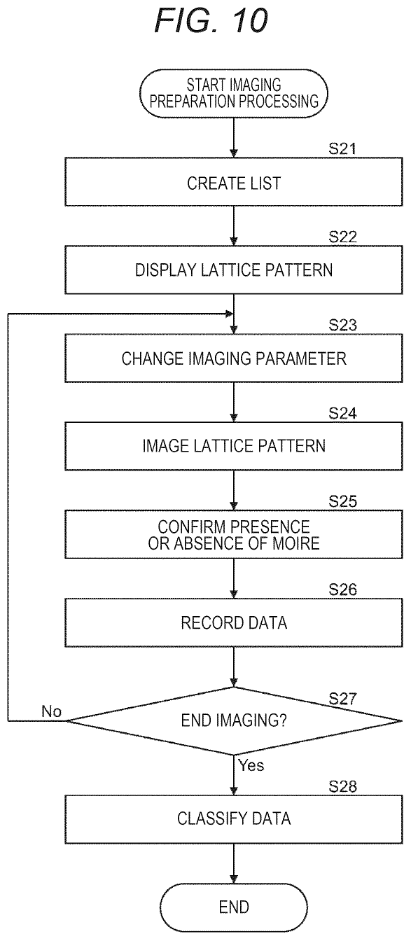

The imaging preparation processing performed by the imaging system 1 of the present technology will be described with reference to a flowchart of FIG. 10.

In step S21, the imaging control unit 53 creates a list indicating combinations of imaging parameters on the basis of, for example, a size of the studio serving as an imaging environment and specifications of the camera 11.

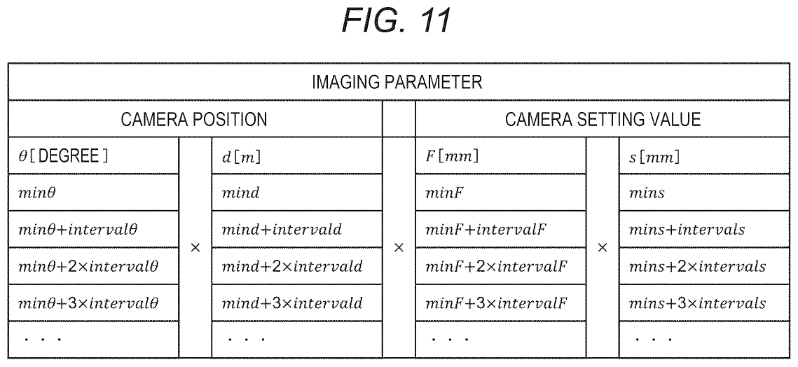

FIG. 11 is a diagram illustrating an example of the list indicating the combinations of the imaging parameters. The value representing the camera position and the camera setting value have a correspondence relationship as illustrated in FIG. 11, for example.

In the example of FIG. 11, examples of the angle θ of the camera 11 with respect to the LED display 12 include minθ, minθ+intervalθ, minθ+2×intervalθ, and minθ+3×intervalθ. minθ is a minimum angle between the camera 11 and the LED display 12 in the studio, and intervalθ is an interval of an angle for detecting the presence or absence of moire.

In the example of FIG. 11, examples of the distance d between the camera 11 and the LED display 12 include mind, mind+intervald, mind+2×intervald, and mind+3×intervald. mind is a shortest distance between the camera 11 and the LED display 12 in the studio, and intervald is an interval of a distance for detecting the presence or absence of moire.

In the example of FIG. 11, examples of the focal length F include minF, minF+intervalF, minF+2×intervalF, and minF+3×intervalF. minF is a shortest focal length in the camera 11, and intervalF is an interval of a focal length for detecting the presence or absence of moire.

In the example of FIG. 11, examples of the focus s include mins, mins+intervals, mins+2×intervals, and mins+3×intervals. mins is a minimum focus in the camera 11, and intervals is an interval of a focus for detecting the presence or absence of moire.

As described above, for example, in a case where there are four values for each type of the imaging parameters, the imaging parameters are combined in a brute-force manner, and 256 combinations are listed. Note that the type of the imaging parameter and the interval for detecting the presence or absence of moire are appropriately changed according to the imaging environment and the specifications of the camera.

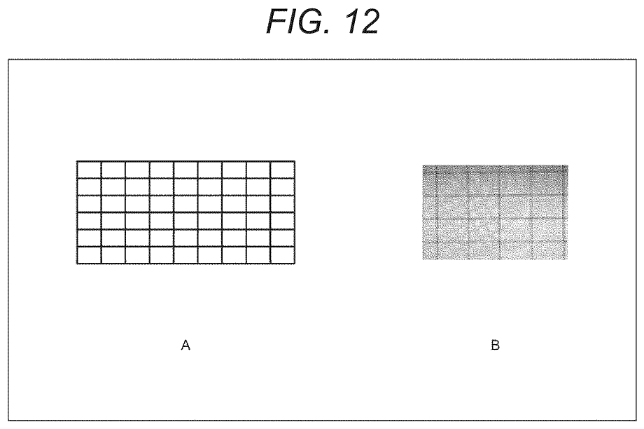

Returning to FIG. 10, in step S22, the LED display 12 displays, for example, a lattice pattern illustrated in A of FIG. 12.

In step S23, the imaging system 1 changes a current camera position and a camera setting value according to the list. For example, the imaging system 1 selects one combination from the listed combinations of the imaging parameters, and changes the current camera position and camera setting value such that the selected camera position and the camera setting value are obtained.

Specifically, the camera position transmission unit 72 transmits information indicating the camera position included in the combination selected from the list to the camera monitor, and causes the monitor to display the information. Furthermore, the camera setting value control unit 63 controls the imaging unit 61 such that the camera setting value included in the combination selected from the list is obtained.

In step S24, the imaging unit 61 images the lattice pattern displayed on the LED display 12 and acquires a captured image.

In step S25, the moire detection unit 91 confirms the presence or absence of moire on the basis of the captured image. As illustrated in B of FIG. 12, the moire detection unit 91 detects the moire occurring in the captured image in which the lattice pattern is imaged.

In step S26, the recording unit 92 records data in which the camera setting value, the camera position, and the moire detection result are associated with each other in the database. For example, data indicating a moire detection result and a combination of a plurality of types of imaging parameters, such as [1 or 0, θ₀, d₀, F₀, s₀], is recorded in the database. A first item of the data indicates a moire detection result, and in a case where moire is detected, a value of the item indicating the detection result is 1, and in a case where moire is not detected, the value of the item indicating the detection result is 0. In the present disclosure, a value representing the position (relative position) of the camera 11 with respect to the display 12 recorded in the database as the reference imaging parameter may be referred to as a reference value representing a relative position. Note that the value representing the position of the camera 11 may be simply referred to as a position of the camera 11. On the other hand, the camera setting value recorded in the database as the reference imaging parameter may be referred to as a reference setting value.

In step S27, the imaging system 1 determines whether or not to end the imaging. For example, in a case where the presence or absence of moire is confirmed for all the listed combinations, it is determined to end the imaging.

In a case where it is determined in step S27 not to end the imaging, the processing returns to step S23, and the subsequent processing is performed. For example, the presence or absence of moire is confirmed for other listed combinations, and data such as [1 or 0, θ₁, d₁, F₁, s₁] is recorded in the database.

In a case where it is determined to end the imaging in step S27, the processing proceeds to step S28. In step S28, the recording unit 92 classifies the data recorded in the database. Specifically, the recording unit 92 classifies the recorded data into moire-present data groups such as [1, θᵢ, dᵢ, Fᵢ, sᵢ] and moire-absent data groups such as [0, θₘ, dₘ, Fₘ, sₘ]. i indicates an index of the moire-present data groups, and m indicates an index of the moire-absent data groups.

After the data is classified in step S27, the imaging preparation processing ends. As described above, in the imaging preparation processing, the recording unit 92 repeatedly records the presence or absence of moire in the captured image and the imaging parameter in association with each other while changing the imaging parameter, thereby generating the database.

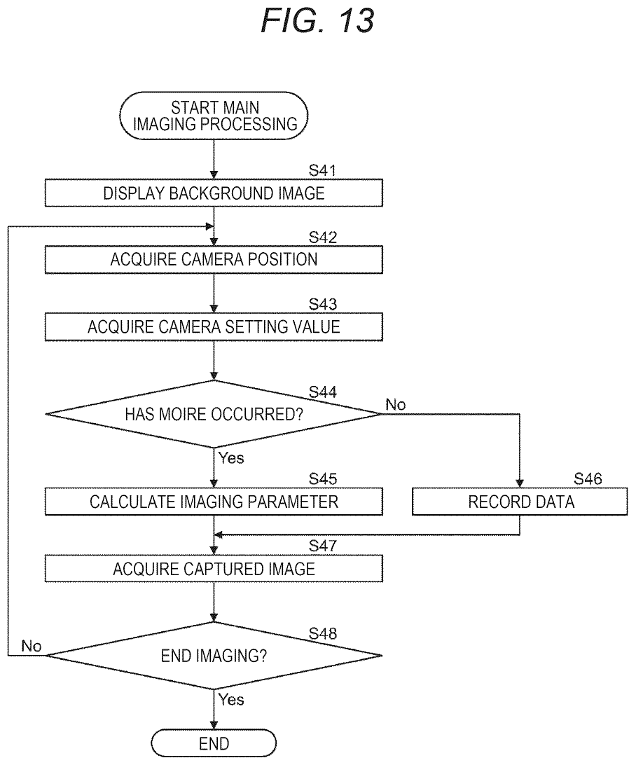

Next, the main imaging processing performed by the imaging system 1 of the present technology will be described with reference to a flowchart of FIG. 13.

In step S41, the LED display 12 displays a background image, and the imaging unit 61 starts imaging.

In step S42, the imaging parameter calculation unit 93 acquires information (current position information) indicating a current value of the camera position.

In step S43, the imaging parameter calculation unit 93 acquires information indicating a current camera setting value.

In step S44, the moire detection unit 91 determines whether or not moire has occurred in the captured image, that is, whether or not moire is present in the captured image.

In a case where it is determined in step S44 that moire has occurred, the processing proceeds to step S45. In step S45, the imaging parameter calculation unit 93 refers to the database recorded in the recording unit 92 on the basis of the current value of the camera position and the current camera setting value, and calculates an imaging parameter that can avoid occurrence of moire.

Specifically, the imaging parameter calculation unit 93 searches for data closest to data indicating current imaging parameters [1, θ_{current}, d_{current}, F_{current}, s_{current}] from the moire-absent data groups [0, θₘ, dₘ, Fₘ, sₘ]. Here, the current imaging parameter is an imaging parameter determined by the photographer, that is, a manual input imaging parameter.

For example, first, the imaging parameter calculation unit 93 calculates θₘ (this θₘ is assumed to be θₚ) at which |θ_{current}−θₘ| becomes the smallest, and searches all data groups [0, θₚ, d_{K}, F_{K}, s_{K}] (K≤(the number of data satisfying θ=θₚ)) including [0, θₚ] from the moire-absent data groups [0, θₘ, dₘ, Fₘ, sₘ].

Next, the imaging parameter calculation unit 93 calculates d_{K} (this d_{K} is assumed to be d_{q}) at which |d_{current}−d_{K}| becomes the smallest, and searches all the data groups [0, θₚ, d_{q}, F_{M}, s_{M}] (M≤(the number of data satisfying θ=θₚ and d=d_{q})) including [0, θₚ, d_{q}] from the data groups [0, θₚ, d_{K}, F_{K}, s_{K}].

Next, the imaging parameter calculation unit 93 calculates F_{M} (this F_{M} is assumed to be Fₛ) at which |F_{current}−F_{M}| becomes the smallest, and searches all the data groups [0, θₚ, d_{q}, Fₛ, s_{N}] (N≤(the number of data satisfying θ=θₚ and d=d_{q} and F=Fₛ)) including [0, θₚ, d_{q}, Fₛ] from the data groups [0, θₚ, d_{q}, F_{M}, s_{M}].

Finally, the imaging parameter calculation unit 93 calculates s_{N} (this s_{N} is assumed to be sᵣ) at which |s_{current}−s_{N}| is the smallest, and searches for data of [0, θₚ, d_{q}, Fₛ, sᵣ] from the data groups [0, θₚ, d_{q}, Fₛ, s_{N}]. θₚ, d_{q}, Fₛ, sᵣ represent a combination of a plurality of types of reference imaging parameters that can avoid occurrence of moire. In this manner, the imaging parameter calculation unit 93 searches for a combination including a plurality of types of reference imaging parameters on the basis of the current position information of the camera 11, for example, and sets the combination as a combination of current imaging parameters. Note that the database may be considered to represent a correspondence relationship between a plurality of combinations of reference imaging parameters and information indicating the presence or absence of moire.

By repeating reference to the reference imaging parameter having the smallest difference from the manual input imaging parameter for each type of the reference imaging parameter in a predetermined order, data (one of combinations of reference imaging parameters) set as the current imaging parameter is selected from the moire-absent data groups.

In the data of [0, θₚ, d_{q}, Fₛ, sᵣ] searched in the order of the angle θ, the distance d, the focal length F, and the focus s, the angle θ among the imaging parameters is a parameter whose value to be changed from the current value is the lowest. Note that the photographer can set the order of the imaging parameters to be searched in a desired order. For example, the photographer sets the search to be performed in order from the imaging parameter that the photographer wants to emphasize (does not want to change the value).

After the reference imaging parameter that can avoid the occurrence of moire is calculated, the imaging control unit 53 transmits the calculated combination of the reference imaging parameters to the camera 11 and reflects the combination in the imaging. Specifically, the camera position transmission unit 72 transmits information indicating the reference value of the camera position included in the combination of the imaging parameters that can avoid the occurrence of moire to the camera monitor and causes the monitor to display the information. Furthermore, the camera setting value control unit 63 controls the imaging unit 61 such that a reference setting value of the camera 11 included in the combination of the imaging parameters that can avoid the occurrence of moire is obtained.

On the other hand, in a case where it is determined in step S44 that moire has not occurred, the processing proceeds to step S46. In step S46, the recording unit 92 additionally records, in the database, data in which the current camera setting value, the current value of the camera position (manual input imaging parameter), and the moire detection result are associated with each other. For example, data such as [0, θₘ₊₁, dₘ₊₁, Fₘ₊₁, sₘ₊₁] is recorded in the database. Even during the main imaging, the combination of the imaging parameters in which the moire does not occur is recorded in the database, so that the calculation accuracy of the reference imaging parameter that can avoid the occurrence of moire can be improved.

After the current imaging parameter is changed in step S45 or after the data is recorded in step S46, the processing proceeds to step S47. In step S47, the imaging unit 61 images the subject with the background image as the background and acquires the captured image.

In step S48, the imaging system 1 determines whether or not to end the imaging.

In a case where it is determined in step S48 not to end the imaging, the processing returns to step S42, and the subsequent processing is performed. In a case where it is determined to end the imaging in step S48, the main imaging processing ends.

Through the above processing, the imaging system 1 can automatically calculate an imaging parameter suitable for avoiding moire. Since the imaging system 1 automatically controls the imaging unit 61 such that the camera setting value suitable for avoiding moire is obtained, the photographer can easily avoid the occurrence of moire only by moving the camera 11 or changing the orientation of the camera 11 such that the camera position (reference position) displayed on the monitor or the like is obtained.

### 3. Modifications

For example, in a case where it is difficult to perform preliminary imaging, such as when the studio cannot be used before main imaging, it is also possible to construct a database by recording imaging parameters and a moire detection result during the main imaging.

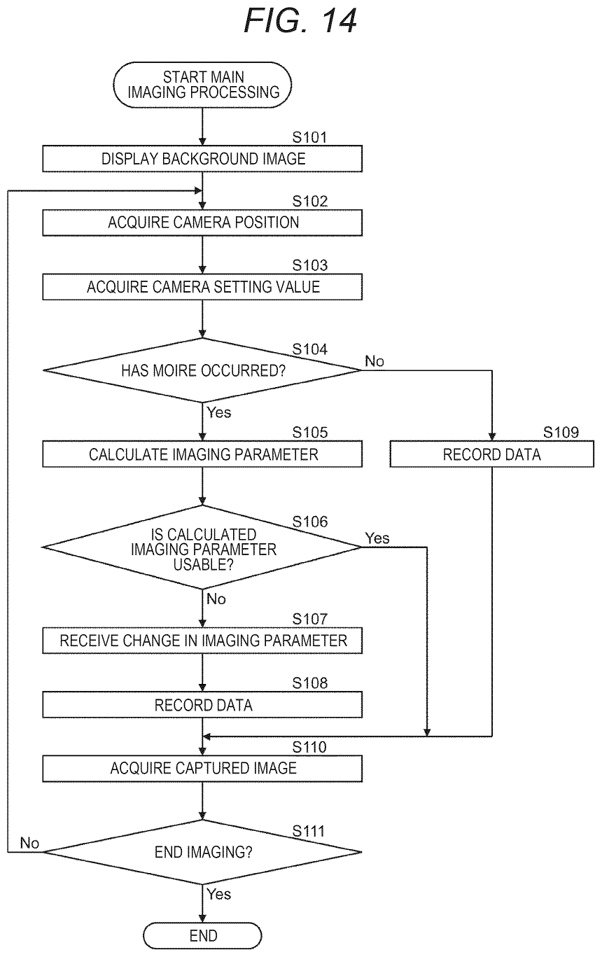

Main imaging processing in a case where imaging preparation processing is not performed will be described with reference to a flowchart of FIG. 14.

Processing from step S101 to step S105 is similar to the processing from step S41 to step S45 in FIG. 13. That is, a background image is displayed on the LED display 12, and a reference imaging parameter that can avoid occurrence of moire is calculated.

In step S106, the imaging control unit 53 determines whether or not the calculated reference imaging parameter is usable, that is, whether or not the reference imaging parameter can be reflected in the camera 11. In a case where the imaging preparation processing is not performed, particularly immediately after the main imaging is started, it is considered that the database is insufficient. Therefore, it is determined whether or not the calculated reference imaging parameter can be reflected in the camera 11.

For example, in a case where all of the conditions of |θ_{current}−θₚ|<error, |d_{current}−d_{q}|<error, |F_{current}−Fₛ|<error, and |s_{current}−sᵣ|<error are satisfied, it is determined that the calculated imaging parameter is usable. The error indicates a predetermined threshold. The photographer can set the threshold error according to the situation of the main imaging.

In a case where it is determined in step S106 that the calculated reference imaging parameter cannot be used, the processing proceeds to step S107. In step S107, the camera 11 receives a change in the current imaging parameter by the photographer. For example, the camera 11 receives the position information of the camera 11 moved by the photographer to avoid the occurrence of moire or the manually adjusted value of the focus s as the changed imaging parameter (adjusted imaging parameter) and transmits the same to the recording unit 92. Note that in a case where it is determined that the calculated reference imaging parameter cannot be used, the monitor of the camera 11 may present information indicating that the imaging parameter cannot be calculated to the photographer. After the current imaging parameter is changed and the occurrence of moire is avoided, the processing proceeds to step S108.

In step S108, the recording unit 92 records data in which the adjusted imaging parameter and the moire detection result are associated with each other in the database.

After the data is recorded in the database in step S108, the processing proceeds to step S110. Furthermore, in a case where it is determined in step S106 that the calculated reference imaging parameter is usable, the processing in steps S107 and S108 is skipped, and the imaging system 1 transmits the calculated reference imaging parameter to the camera 11 as the current imaging parameter and reflects the same in imaging. Thereafter, the processing proceeds to step S110.

In a case where it is determined in step S104 that moire has not occurred, the processing proceeds to step S109. In step S109, the recording unit 92 records data in which the current camera setting value, the current value of the camera position, and the moire detection result are associated with each other in the database. Thereafter, the processing proceeds to step S110.

In step S110, the imaging unit 61 images the subject with the background image as the background and acquires a captured image.

In step S111, the imaging system 1 determines whether or not to end the imaging.

In a case where it is determined in step S111 not to end the imaging, the processing returns to step S102, and the subsequent processing is performed. In a case where it is determined to end the imaging in step S111, the main imaging processing ends.

As described above, even in a case where it is difficult to perform the preliminary imaging, the imaging system 1 can record the imaging parameter and the moire detection result to construct the database during the main imaging, and automatically calculate the reference imaging parameter suitable for avoiding moire.

### Regarding Computer

The series of processes described above can be executed by hardware or can also be executed by software. In a case where the series of processes is executed by software, a program included in the software is installed from a program recording medium on a computer incorporated in dedicated hardware, a general-purpose personal computer, or the like.

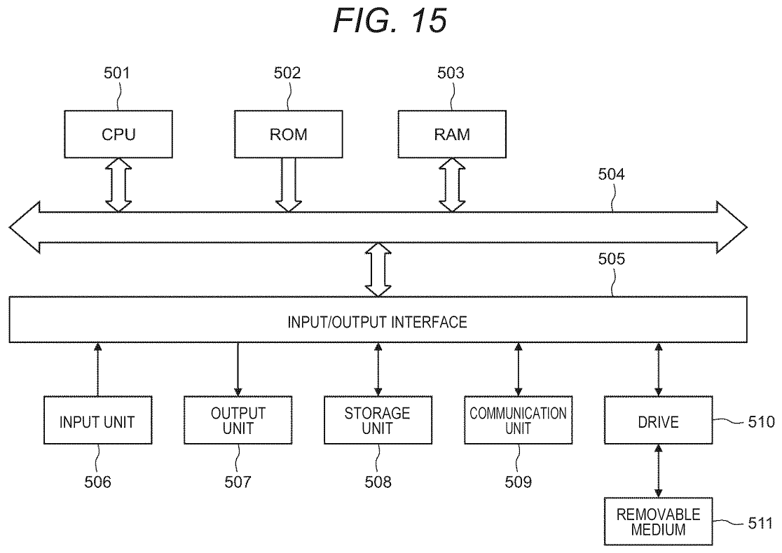

FIG. 15 is a block diagram illustrating a configuration example of hardware of a computer that executes the above-described series of processing in accordance with a program. The imaging control unit 53 is configured by, for example, a PC having a similar configuration to the configuration illustrated in FIG. 15.

A central processing unit (CPU) 501, a read only memory (ROM) 502, and a random access memory (RAM) 503 are mutually connected by a bus 504.

An input/output interface 505 is also connected to the bus 504. An input unit 506 including a keyboard, a mouse, and the like and an output unit 507 including a display, a speaker, and the like are connected to the input/output interface 505. Furthermore, a storage unit 508 including a hard disk, a nonvolatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to execute the above-described series of processes.

For example, the program executed by the CPU 501 is recorded in the removable medium 511, or provided via a wired or wireless transmission medium such as a local area network, the Internet, or digital broadcasting, and then installed in the storage unit 508.

Note that the program to be executed by the computer may be a program that executes processing in time series in accordance with an order described in the present description, or may be a program that executes processing in parallel or at a necessary timing such as when a call is made.

In the present description, a system means a set of a plurality of constituent elements (devices, modules (parts), and the like), and it does not matter whether or not all the constituent elements are placed in the same housing. Therefore, a plurality of devices housed in separate housings and connected to each other via a network, and one device including a plurality of modules housed in one housing, are both systems.

The effects described in the present specification are merely examples and are not limited, and other effects may be provided.

Embodiments of the present technology are not limited to the embodiments described above, and various modifications can be made without departing from the scope of the present technology.

For example, the present technology may be embodied in cloud computing in which one function is shared and processed by a plurality of devices in cooperation via a network.

Furthermore, each step described in the flowchart described above may be performed by a single device, or may be performed by a plurality of devices in a shared manner.

Moreover, in a case where a single step includes a plurality of processes, the plurality of processes included in the single step can be performed by a single device or performed by a plurality of devices in a shared manner.

### Examples of Combinations of Configurations

The present technology can also be configured as follows.

### 1

An information processing device including:
an imaging control unit that refers to a database in which a reference imaging parameter related to imaging by a camera that images a display and information indicating presence or absence of moire in a captured image captured by the camera are recorded in association with each other to set the reference imaging parameter associated with information indicating absence of the moire as a current imaging parameter of the camera.

### 2

The information processing device according to (1), in which
the reference imaging parameter includes at least one of a reference setting value of the camera or a reference value representing a relative position of the camera with respect to the display.

### 3

The information processing device according to (2), in which
the reference value representing the relative position of the camera represents a distance between the camera and the display and an angle of the camera with respect to the display.

### 4

The information processing device according to (3), in which
a reference setting value of the camera represents at least one of a focal length or a focus, and corresponds to the reference value representing the relative position of the camera.

### 5

The information processing device according to (3) or (4), in which
the imaging control unit
acquires current position information of the camera,
searches for the reference imaging parameter on a basis of the current position information of the camera and the reference value representing the relative position of the camera, and
transmits the searched reference imaging parameter to the camera as the current imaging parameter.

### 6

The information processing device according to (5), in which
the imaging control unit presents the set relative position of the camera on a monitor of the camera.

### 7

The information processing device according to (5) or (6), in which
the imaging control unit transmits a set reference setting value of the camera to the camera.

### 8

The information processing device according to any one of (5) to (7), in which
the imaging control unit
acquires a manual input imaging parameter from the camera, and
sets, as the current imaging parameter, the reference imaging parameter having a smallest difference from the manual input imaging parameter among the reference imaging parameters associated with information indicating absence of the moire in the database.

### 9

The information processing device according to any of (8), in which
the imaging control unit sets a combination of a plurality of types of the reference imaging parameters as a combination of the current imaging parameters on a basis of current position information of the camera.

### 10

The information processing device according to (9), in which
the database represents a correspondence relationship between a plurality of combinations of the reference imaging parameters and information indicating presence or absence of the moire.

### 11

The information processing device according to (10), in which
the imaging control unit selects one combination associated with information indicating absence of the moire from among the plurality of combinations of the reference imaging parameters in setting of the reference imaging parameter having a smallest difference from the manual input imaging parameter.

### 12

The information processing device according to any one of (5) to (11), in which
the imaging control unit
acquires a manual input imaging parameter from the camera,
determines whether or not the moire is present in the captured image at a current position of the camera, and
records the manual input imaging parameter and information indicating absence of the moire in the database in association with each other on a basis of determination that the moire is not present in the captured image.

### 13

The information processing device according to (12), in which
in a case where it is determined that the moire is present in the captured image, the imaging control unit determines whether or not the reference imaging parameter set can be reflected in the camera on a basis of a difference between the set reference imaging parameter and the manual input imaging parameter, and
transmits the set reference imaging parameter to the camera on a basis of determination that the set reference imaging parameter can be reflected in the camera.

### 14

The information processing device according to (13), in which
in a case where the difference between the manual input imaging parameter and the set reference imaging parameter is smaller than a predetermined threshold, the imaging control unit determines that the set reference imaging parameter can be reflected in the camera.

### 15

The information processing device according to (13) or (14), in which
in a case where it is determined that the set reference imaging parameter cannot be reflected in the camera, the imaging control unit acquires an adjusted imaging parameter different from the manual input imaging parameter from the camera, and
records the adjusted imaging parameter and information indicating presence or absence of the moire in the database.

### 16

The information processing device according to any one of (1) to (15), further including:
the camera;
a camera position tracking unit that estimates a current position of the camera; and
the display that displays an image rendered on a basis of the current imaging parameter and the current position of the camera.

### 17

An information processing method including:
by an information processing device,
referring to a database in which a reference imaging parameter related to imaging by a camera that images a display and information indicating presence or absence of moire in a captured image captured by the camera are recorded in association with each other to set the reference imaging parameter associated with information indicating absence of the moire as a current imaging parameter of the camera.

### 18

A computer-readable recording medium recording a program for executing processing, the processing including:
referring to a database in which a reference imaging parameter related to imaging by a camera that images a display and information indicating presence or absence of moire in a captured image captured by the camera are recorded in association with each other to set the reference imaging parameter associated with information indicating absence of the moire as a current imaging parameter of the camera.

### REFERENCE SIGNS LIST

1 Imaging system
11 Camera
12 LED display
51 Camera position tracking unit
52 Background image display unit
53 Imaging control unit
61 Imaging unit
62 Camera setting value transmission unit
63 Camera setting value control unit
71 Camera position estimation unit
72 Camera position transmission unit
81 Camera position acquisition unit
82 Camera setting value acquisition unit
91 Moire detection unit
92 Recording unit
93 Imaging parameter calculation unit

1.1 An information processing device comprising:
an imaging control unit that refers to a database in which a reference imaging parameter related to imaging by a camera that images a display and information indicating presence or absence of moire in a captured image captured by the camera are recorded in association with each other to set the reference imaging parameter associated with information indicating absence of the moire as a current imaging parameter of the camera.

2. The information processing device according to claim 1, wherein
the reference imaging parameter includes at least one of a reference setting value of the camera or a reference value representing a relative position of the camera with respect to the display.

3. The information processing device according to claim 2, wherein
the reference value representing the relative position of the camera represents a distance between the camera and the display and an angle of the camera with respect to the display.

4. The information processing device according to claim 3, wherein
a reference setting value of the camera represents at least one of a focal length or a focus, and corresponds to the reference value representing the relative position of the camera.

5. The information processing device according to claim 3, wherein
the imaging control unit
acquires current position information of the camera,
searches for the reference imaging parameter on a basis of the current position information of the camera and the reference value representing the relative position of the camera, and
transmits the searched reference imaging parameter to the camera as the current imaging parameter.

6. The information processing device according to claim 5, wherein
the imaging control unit presents the set relative position of the camera on a monitor of the camera.

7. The information processing device according to claim 5, wherein
the imaging control unit transmits a set reference setting value of the camera to the camera.

8. The information processing device according to claim 5, wherein
the imaging control unit
acquires a manual input imaging parameter from the camera, and
sets, as the current imaging parameter, the reference imaging parameter having a smallest difference from the manual input imaging parameter among the reference imaging parameters associated with information indicating absence of the moire in the database.

9. The information processing device according to claim 8, wherein
the imaging control unit sets a combination of a plurality of types of the reference imaging parameters as a combination of the current imaging parameters on a basis of current position information of the camera.

10. The information processing device according to claim 9, wherein
the database represents a correspondence relationship between a plurality of combinations of the reference imaging parameters and information indicating presence or absence of the moire.

11. The information processing device according to claim 10, wherein
the imaging control unit selects one combination associated with information indicating absence of the moire from among the plurality of combinations of the reference imaging parameters in setting of the reference imaging parameter having a smallest difference from the manual input imaging parameter.

12. The information processing device according to claim 5, wherein
the imaging control unit
acquires a manual input imaging parameter from the camera,
determines whether or not the moire is present in the captured image at a current position of the camera, and
records the manual input imaging parameter and information indicating absence of the moire in the database in association with each other on a basis of determination that the moire is not present in the captured image.

13. The information processing device according to claim 12, wherein
in a case where it is determined that the moire is present in the captured image, the imaging control unit determines whether or not the reference imaging parameter set can be reflected in the camera on a basis of a difference between the set reference imaging parameter and the manual input imaging parameter, and
transmits the set reference imaging parameter to the camera on a basis of determination that the set reference imaging parameter can be reflected in the camera.

14. The information processing device according to claim 13, wherein
in a case where the difference between the manual input imaging parameter and the set reference imaging parameter is smaller than a predetermined threshold, the imaging control unit determines that the set reference imaging parameter can be reflected in the camera.

15. The information processing device according to claim 13, wherein
in a case where it is determined that the set reference imaging parameter cannot be reflected in the camera, the imaging control unit acquires an adjusted imaging parameter different from the manual input imaging parameter from the camera, and
records the adjusted imaging parameter and information indicating presence or absence of the moire in the database.

16. The information processing device according to claim 1, further comprising:
the camera;
a camera position tracking unit that estimates a current position of the camera; and
the display that displays an image rendered on a basis of the current imaging parameter and the current position of the camera.

17. An information processing method comprising:
by an information processing device,
referring to a database in which a reference imaging parameter related to imaging by a camera that images a display and information indicating presence or absence of moire in a captured image captured by the camera are recorded in association with each other to set the reference imaging parameter associated with information indicating absence of the moire as a current imaging parameter of the camera.

18. A computer-readable recording medium recording a program for executing processing, the processing comprising:
referring to a database in which a reference imaging parameter related to imaging by a camera that images a display and information indicating presence or absence of moire in a captured image captured by the camera are recorded in association with each other to set the reference imaging parameter associated with information indicating absence of the moire as a current imaging parameter of the camera.
